(19) United States
(12) Patent Application Publication
(10) Pub. No.: US 2016/0107894 A1
(43) Pub. Date: Apr. 21, 2016

(54) METHOD FOR PRODUCING GRANULAR POLYSILICON

(71) Applicant: WACKER CHEMIE AG, München (DE)

(72) Inventor: Simon PEDRON, Burghausen (DE)

(73) Assignee: WACKER CHEMIE AG, Munich (DE)

(21) Appl. No.: 14/893,015

(22) PCT Filed: May 21, 2014
(86) PCT No.: PCT/EP2014/060425

§ 371 Date: Nov. 20, 2015

(30) Foreign Application Priority Data
May 29, 2013 (DE) 10 2013 210 039.6

(51) Int. Cl. C01B 33/03

(52) U.S. Cl. CPC C01B 33/03

(57) ABSTRACT

Production of granular polysilicon is made more economical by extracting heat from the hot off-gas from the fluidized bed reactor to heat at least one of a fluidizing gas, reactant gas, silicon feed particles, or an aqueous medium.

### CROSS REFERENCE TO RELATED APPLICATIONS

This application is the U.S. National Phase of PCT Appln. No. PCT/EP2014/060425 filed May 21, 2014, which claims priority to German Application No. 10 2013 210 039.6 filed May 29, 2013, the disclosures of which are incorporated in their entirety by reference herein.

### BACKGROUND OF THE INVENTION

1. Field of the Invention

The invention relates to a process for producing granular polysilicon.

2. Description of the Related Art

Polycrystalline silicon granules, or polysilicon granules for short, are an alternative to the polysilicon produced in the Siemens process. Whereas the polysilicon is produced in the Siemens process as a cylindrical silicon rod, which, before further processing thereof, must be comminuted to produce what is termed chip poly in a time-consuming and costly manner and may also need to be cleaned, polysilicon granules have the properties of bulk goods and can be used directly as a raw material, e.g. for monocrystalline production for the photovoltaics and electronics industries.

Polysilicon granules are produced in a fluidized-bed reactor. This is carried out by fluidizing silicon particles by means of a gas flow in a fluidized bed, wherein the bed is heated up to high temperatures via a heater. By adding a silicon-containing reaction gas, a pyrolysis reaction proceeds on the hot particle surfaces. In this process elemental silicon is deposited on the silicon particles and the individual particles grow in diameter. Owing to the regular take-off of grown particles and addition of smaller silicon particles as seed particles (termed “seed” in the further course of the document), the process can be operated continuously with all of the advantages associated therewith. As silicon-containing reactant gases, silicon-halogen compounds (e.g. chlorosilanes or bromosilanes), monosilane (SiH₄), and mixtures of these gases with hydrogen are described. Such deposition methods and devices therefor are known, for example, from U.S. Pat. No. 4,786,477 A.

Silicon deposition in a fluidized-bed reactor with silanes (SiHₙX₄₋ₙ where X=halogen, n=0-4) usually takes place at temperatures between 600° C. and 1200° C. Feed gas streams must be heated up, off-gas streams and the solid product (polycrystalline granules) must be cooled for cleaning and/or further processing.

Since in the production of polysilicon the production costs are becoming of increasingly greater importance, it would be desirable to save heating energy. In this respect, in the prior art, some proposals have already been made.

U.S. Pat. No. 6,827,786 B2 discloses a reactor for producing granular polysilicon, comprising a heat zone beneath the reaction zone having one or more tubes which are heated by one or more heaters, a mechanism which allows silicon granules to be pulsed to and fro between heating and reaction zones, wherein this mechanism comprises a separate inlet for introducing silicon-free gas into the heating zone, a separate inlet for introducing silicon-containing gas into the reaction zone, and a heating means for heating the silicon-free gas to a reaction temperature. It is known that heat can be recovered from the granules that are branched off by means of a heat exchanger, by heating up incoming silanes. A problem, however, is the formation of wall deposit due to the silicon-containing gas, if the wall temperature is too high. The granules, by direct contact with the silicon-containing gas, can also give off heat thereto.

US 2011212011 A1 discloses a process for producing polycrystalline silicon granules in which the off-gas heat is used for heating up seed particles by means of heat exchangers.

US 2012207662 A1 discloses a reactor for producing polycrystalline silicon (Siemens process, cylindrical silicon rods), in which heat is recovered by a coolant for reactor cooling. By using hot water having a temperature above the boiling point of the coolant and pressure reduction of the hot water, some of the hot water is withdrawn from the reactor in the form of steam and used as a source of heat for other applications.

From the problems described there resulted the objective of the invention.

### SUMMARY OF THE INVENTION

The problem of heat recovery in granular polysilicon production is solved by a process for producing granular polysilicon in a fluidized-bed reactor, comprising fluidizing silicon particles by means of a fluidizing gas feed in a fluidized bed which is heated to a temperature of 600-1200° C., adding a silicon-containing reaction gas and depositing silicon on the silicon particles, forming granular polysilicon is which is then removed from the reactor, and also removing off-gas, wherein off-gas that is removed is used for heating up fluidizing gas or reaction gas, or for heating up an aqueous medium in a twin-tube o tube-bundle heat exchanger.

### BRIEF DESCRIPTION OF THE DRAWINGS

FIG. 1 shows schematically how, in a fluidized-bed reactor, off-gas is used for heating up feed gas streams.

FIG. 2 shows schematically how, in a fluidized-bed reactor, off-gas is used for heating up seed particles.

FIG. 3 shows schematically how, in a fluidized-bed reactor, product granules are used for heating up fluidizing gas.

FIG. 4 shows schematically how, in a fluidized-bed reactor, off-gas is used for heating up cooling water.

### DETAILED DESCRIPTION OF THE PREFERRED EMBODIMENTS

Preferably, as fluidizing gases, H₂, N₂ Ar or SiCl₄ are used. The silicon-containing reaction gas is preferably a silane (SiH₄₋ₙClₙ, n=0-4) or a mixture of silane and H₂, N₂, Ar or SiCl₄.

Preferably, the aqueous medium that is heated up is used for generating electricity or steam or for heating up another medium having a temperature lower than the aqueous medium that is heated up. Preferably, the off-gas heats up a cooling water stream in a heat exchanger, which cooling water stream is then used for generating electricity or for heating up a medium having a lower temperature, or which is then evaporated.

Preferably, off-gas that is removed is used for heating up fluidizing gas or reaction gas, and for heating up a cooling water stream in a heat exchanger.

In addition, granular polysilicon that is removed is preferably used for heating up the fluidizing gas. For this purpose, most preferably, fluidizing gas flows round the granular polysilicon in a container or in a pipe, and in this process heat is released to the fluidizing gas by direct contact.

Likewise, it is preferred that the off-gas is used for heating silicon particles, wherein the heat exchange proceeds by the means that off-gas flows round the silicon particles in a container or in a pipe, and in the process the silicon particles take up heat from the off-gas direct contact.

In a preferred embodiment, the off-gas heats both the gas streams that are fed, namely fluidizing gas and reaction gas, wherein two heat exchangers are used.

As heat exchanger, a twin-tube, or a tube-bundle heat exchanger is preferred.

The heat removed from the reactor via the off-gas can be used for heating up one or more feed gas streams and in addition the seed material.

Since the off-gas stream also contains dust-form silicon which has a tendency to form wall deposits in heat exchangers, in the selection of the heat exchangers, apparatuses having large flow-cross sections are to be preferred. When reagent gas is heated up with the off-gas, twin-tube or tube-bundle heat exchangers are particularly suitable.

The off-gas heat can be utilized by the off-gas flowing through a container in which seed particles are present, as a result of which the seed particles are heated up. Instead of a container, a pipe can alternatively be used, via which both material streams are brought into direct contact and through which they especially flow in counterflow.

The invention therefore provides utilizing off-gas heat in order to heat up feed gas or generate steam. In addition, the invention provides utilizing granules for steam generation.

It has been found that utilizing the off-gas heat for heating up media or for steam generation contributes markedly more to the energy efficiency of the process than the utilization of the off-gas heat of the granules.

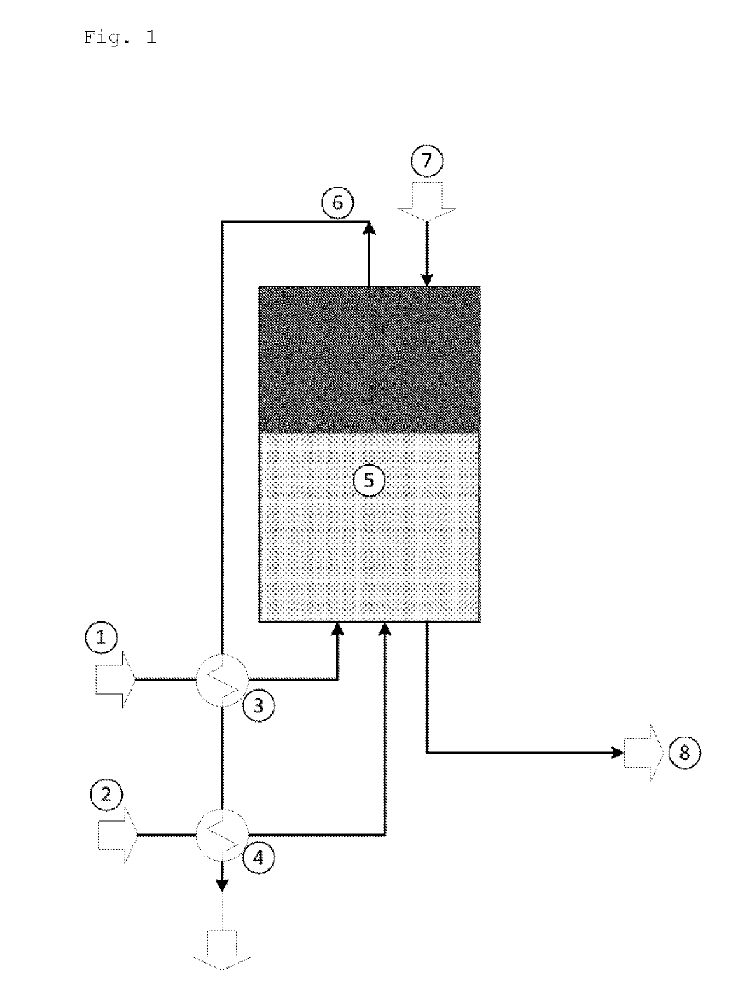

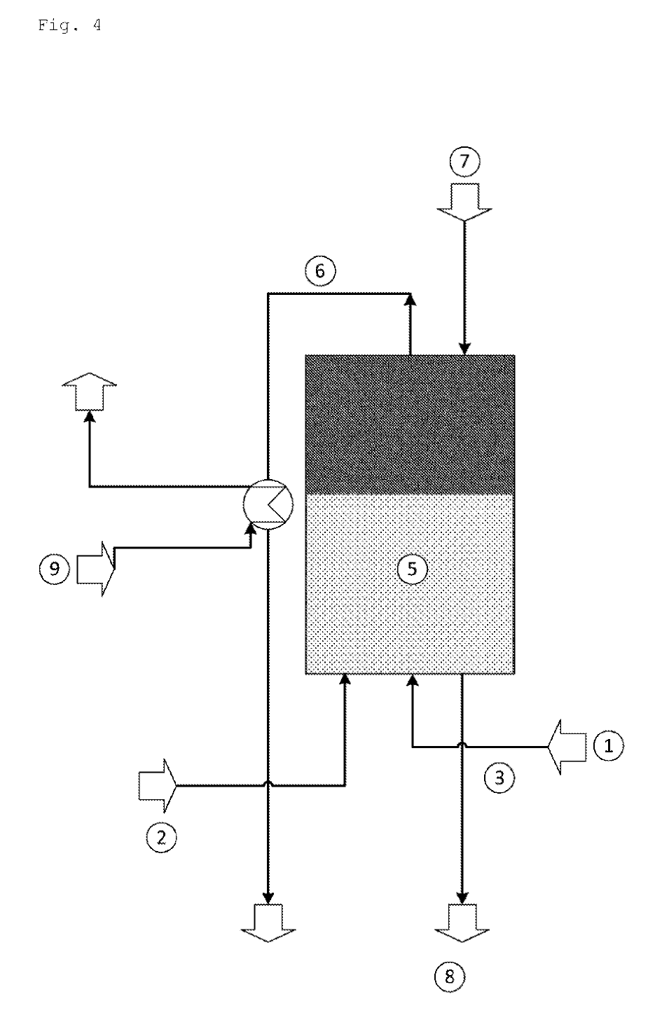

The invention will be described hereinafter with reference to examples and with reference to FIGS. 1-4.

### LIST OF REFERENCE SYMBOLS USED

1 Feed gas stream 1
2 Feed gas stream 2
3 Heat exchanger 1
4 Heat exchanger 2
5 Fluidized-bed reactor
6 Reactor off-gas
7 Seed
8 Product granules
9 Cooling water

### EXAMPLES

A fluidized-bed process for silicon deposition from trichlorosilane using H₂ as a secondary gas (fluidizing gas) is considered.

The deposition process takes place at a temperature of 1000° C. and a pressure of 6 bar(abs).

The material stream of H₂ is 24.66 kg/h.

A trichlorosilane/H₂ mixture having a mol fraction of 70% TCS is added as primary gas (reaction gas) at a mass stream of 875.55 kg/h. This reaction gas may be preheated to a maximum of 350° C. to avoid silicon deposits in the feed lines.

In chemical equilibrium, there results therefrom at a mass stream of 860.81 kg/h of off-gas, a net deposition rate of 33.85 kg/h of silicon, wherein 5% is lost as wall deposition in the reactor and as dust via the off-gas path, providing a net deposition rate of 32.16 kg/h of silicon. Seed particles are added to the reactor at a rate of 5 kg/h.

It is assumed that the off-gas cools from 1000° C. to 850° C. owing to diverse cooled internals and heat losses in the off-gas tube.

In the calculation of k*A values for heat exchangers, in each case the counterflow heat exchanger model is used as a basis.

### Example 1

In this embodiment, which is shown schematically in FIG. 1, the off-gas 6 heats up both gas streams 1 and 2 that are fed. For this purpose, two heat exchangers 3 and 4 are used.

The H₂ stream 1 is not subject to an upper temperature limit, for which reason, it is heated up in a first heat exchanger 3 at a relatively high temperature level.

Then, the off-gas 6 heats up the TCS/H₂ gas mixture (feed gas stream 2) to a temperature of approximately 350° C. by means of heat exchanger 4.

Overall, an amount of heat of 136.9 kW can be recovered from the process.

Exact values for the heat exchangers 3,4 may be found in table 1 and table 2.

Table 1 shows data for heat exchanger 3.

TABLE 1

| | | |
|---|---|---|
| Inlet temperature off-gas | 850.00 | ° C. |
| Outlet temperature off-gas | 584.12 | ° C. |
| Inlet temperature H₂ | 20.00 | ° C. |
| Outlet temperature H₂ | 800.00 | ° C. |
| Heat transferred | 78.50 | kW |
| Delta T log | 212.16 | ° C. |
| k*A heat exchanger | 370.00 | W/K |

Table 2 shows data for heat exchanger 4.

TABLE 2

| | | |
|---|---|---|
| Inlet temperature off-gas | 584.12 | ° C. |
| Outlet temperature off-gas | 381.60 | ° C. |
| Inlet temperature H₂/TCS | 20.00 | ° C. |
| Outlet temperature H₂/TCS | 350.00 | ° C. |
| Heat transferred | 58.37 | kW |
| Delta T log | 293.26 | ° C. |
| k*A heat exchanger | 199.03 | W/K |

Since the off-gas 6 can also contain fine silicon dust, the heat exchangers 3, 4 should not have geometries having excessively narrow cross sections.

For example, a twin-tube or tube-bundle heat exchanger are useful.

### Example 2

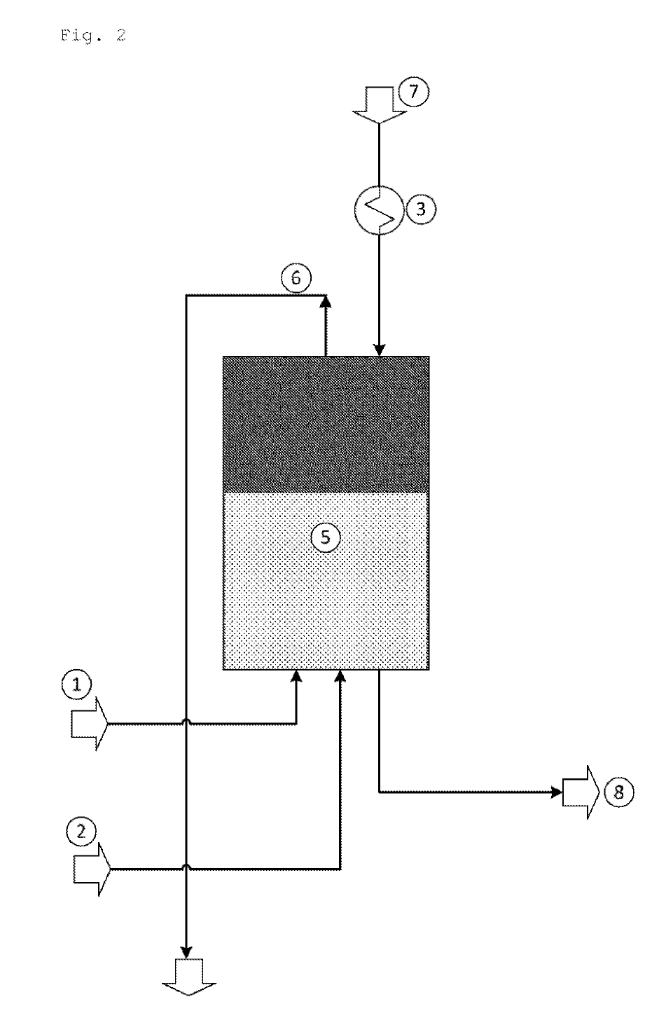

In this embodiment, which is shown schematically in FIG. 2, the off-gas 6 preheats the fed seed 7.

Only a minimal amount of heat of 1.02 kW is necessary.

The heat can be transferred, for example, by the container with seed 7 being flushed by hot off-gas 6.

Table 3 shows data for the heat exchanger.

TABLE 3

| | | |
|---|---|---|
| Inlet temperature off-gas | 850.00 | ° C. |
| Outlet temperature off-gas | 846.58 | ° C. |
| Inlet temperature seed | 20.00 | ° C. |
| Outlet temperature seed | 835.00 | ° C. |
| Heat transferred | 1.02 | kW |
| Delta T log | 202.43 | ° C. |
| k*A heat exchanger | 5.04 | W/K |

### Example 3

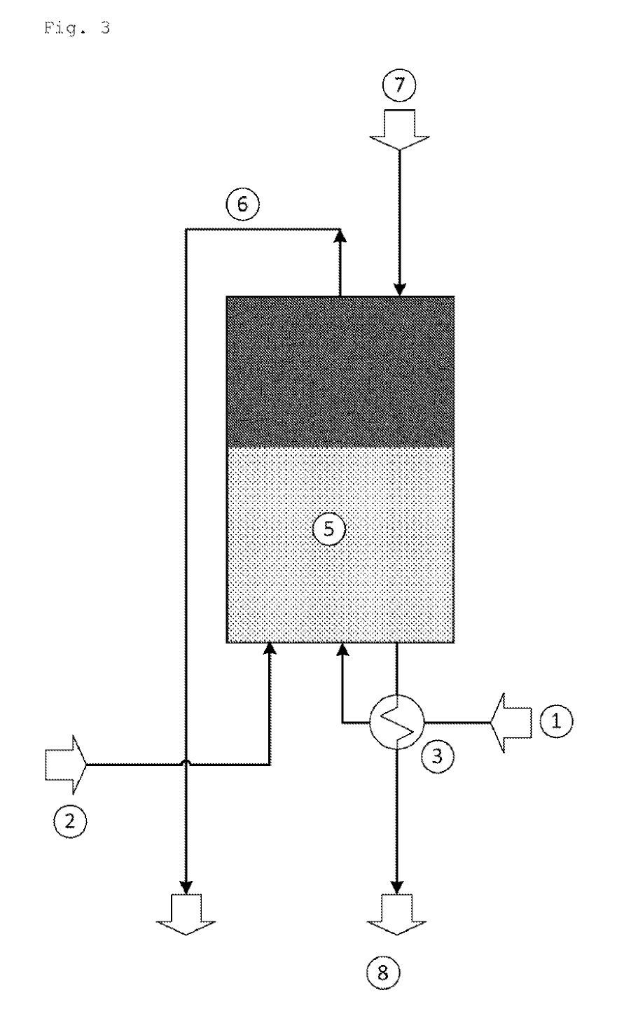

This example is shown schematically in FIG. 3. It is not subject matter of the patent, but is only given for comparison with the other scenarios.

The product granules 8 having a mass stream of 37.16 kg/h (32.16 kg/h net deposition+5 kg/h of seed) heats up the H₂ feed gas stream 1.

It is assumed that the granular silicon 8 cools from 1000° C. to 900° C. via diverse cooled internals and on the way to the heat exchanger 3.

In the heat exchanger 3, an amount of heat of 8.22 kW is transferred.

Similarly to example 2, the use of a product container in which preferably H₂ flows through the hot granules from the reactor is conceivable.

It is clear that, via utilization of the off-gas heat for feed preheating, an amount of energy higher by more than an order of magnitude can be recovered than via recovery of waste-heat of granules 8.

Table 4 shows data for the heat exchanger.

TABLE 4

| | | |
|---|---|---|
| Inlet temperature H₂ | 20.00 | ° C. |
| Outlet temperature H₂ | 104.65 | ° C. |
| Inlet temperature granules | 900.00 | ° C. |
| Outlet temperature granules | 25.00 | ° C. |
| Heat transferred | 8.22 | kW |
| Delta T log | 155.91 | ° C. |
| k*A heat exchanger | 52.74 | W/K |

### Example 4

Off-gas mass stream 6 heats up a cooling water stream 9 in a heat exchanger.

This cooling water stream is at a pressure of 10 bar(abs) and is heated to 170° C. (boiling temperature: 180° C.)

The cooling water that is heated up can be used afterwards, for example, for heating up media having a low temperature level.

Likewise, in a subsequent flash evaporation of the water stream or by giving off the heat in an evaporator to a water stream having a lower pressure, steam can be generated for producing electricity.

At 211 kW, in comparison with the other examples, much heat is transferred. Therefore, this embodiment is particularly preferred.

Table 5 shows data for the heat exchanger.

TABLE 5

| | | |
|---|---|---|
| Mass stream of cooling water | 1075 | kg/h |
| Inlet temperature cooling water | 20.00 | ° C. |
| Outlet temperature cooling water | 170.00 | ° C. |
| Inlet temperature off-gas | 850.00 | ° C. |
| Outlet temperature off-gas | 123.17 | ° C. |
| Heat transferred | 210.51 | kW |
| Delta T log | 305.89 | ° C. |
| k*A | 688.18 | W/K |

1.-12. (canceled)

13. A process for producing granular polysilicon in a fluidized-bed reactor, comprising fluidizing silicon particles by a fluidizing gas feed in a fluidized bed which is heated to a temperature of 600-1200° C., adding a silicon-containing reaction gas and depositing silicon on the silicon particles whereby a granular polysilicon product is formed; removing the granular polysilicon product from the reactor, and removing off-gas from the reactor,
wherein off-gas that is removed is used for heating up fluidizing gas and/or reaction gas by heat exchange in a twin-tube or tube-bundle heat exchanger.

14. The process of claim 13, wherein at least one fluidizing gas is selected from the group consisting of H₂, N₂ Ar or SiCl₄, and a silane (SiH₄₋ₙXₙ, n=0-4, X=halogen) or a mixture of one or more silanes and H₂, N₂, Ar or SiCl₄ is used as a reaction gas.

15. The process of claim 13, wherein granular polysilicon product is removed from the reactor is used for heating the fluidizing gas.

16. The process of claim 15, wherein fluidizing gas flows around the granular polysilicon product in a container or in a pipe, and in this process heat is released to the fluidizing gas by direct contact with the granular polysilicon product.

17. The process of claim 13, wherein the off-gas is used for heating silicon feed particles, wherein heat exchange proceeds by contacting the off-gas with silicon feed particles in a container or in a pipe, and in the process the silicon particles absorb heat from the off-gas by direct contact with the off-gas.

18. The process of claim 13, wherein the off-gas heats both the fluidizing gas and reaction gas, wherein at least two twin-tube, or tube-bundle heat exchangers are used, at least one heat exchanger for each gas stream.

19. A process for producing granular polysilicon in a fluidized-bed reactor, comprising fluidizing silicon particles by a fluidizing gas feed in a fluidized bed which is heated to a temperature of 600-1200° C., adding a silicon-containing reaction gas and depositing silicon on the silicon particles whereby a granular polysilicon product is formed; removing the granular polysilicon product from the reactor, and removing off-gas from the reactor,
wherein off-gas removed from the reactor heats an aqueous medium by heat exchange from the off-gas in a heat exchanger to form a heated aqueous medium, and the heated aqueous medium is used for generating electricity or steam or for heating another medium having a temperature lower than the heated aqueous medium.

20. The process of claim 19, wherein a twin-tube or tube-bundle heat exchanger is used as a heat exchanger.

21. The process of claim 19, wherein at least one of H₂, N₂ Ar and/or SiCl₄ are used as a fluidizing gas, and one or more silanes (SiH₄₋ₙXₙ, n=0-4, X=halogen) or a mixture of silane(s) and H₂, N₂, Ar or SiCl₄ is used as a reactant gas.

22. The process of claim 19, wherein granular polysilicon product removed from the reactor is used for heating the fluidizing gas.

23. The process of claim 22, wherein fluidizing gas flows around the granular polysilicon product in a container or in a pipe, and in this process heat is released to the fluidizing gas by direct contact with the granular silicon product.

24. The process of claim 19, wherein the off-gas is used for heating silicon feed particles, wherein heat exchange proceeds by contacting the off-gas with the silicon feed particles in a container or in a pipe, and in the process the silicon particles absorb heat from the off-gas by direct contact with the off-gas.
